(19) United States
(12) Patent Application Publication
(10) Pub. No.: US 2025/0242345 A1
(43) Pub. Date: Jul. 31, 2025

(54) MICROFLUIDIC FLOW CELL

(71) Applicant: LUMICKS DSM Holding B.V., AMSTERDAM (NL)

(72) Inventors: Serena Alba Davoli, Amsterdam (NL); Loïc Chaubet, Amsterdam (NL); Thomas Adriaan Cohen Stuart, Zeist (NL); Willem Otto De Jong, Utrecht (NL)

(21) Appl. No.: 18/870,635

(22) PCT Filed: May 31, 2023
(86) PCT No.: PCT/EP2023/064515

§ 371 Date: Nov. 29, 2024

(30) Foreign Application Priority Data
Jun. 2, 2022 (EP) 22177022.5
Jul. 29, 2022 (EP) 22187792.1

(51) Int. Cl. B01L 3/00

(52) U.S. Cl. CPC B01L 3/50273; B01L 3/502761; B01L 2200/027; B01L 2200/0652; B01L 2200/0668; B01L 2300/0816; B01L 2300/0887; B01L 2300/161; B01L 2400/0454

(57) ABSTRACT

The invention relates to a microfluidic flow cell intended for imaging a fluid, comprising a body which houses at least one fluid channel extending between a fluid inlet and a fluid outlet, wherein the at least one fluid channel comprises a channel part which is located at an imaging region intended for imaging said fluid present in the channel part of the fluid channel. On the body at least one fluid barrier is provided intended for preventing fluid (accidentally) spilled from, or in the vicinity of, any of the fluid inlet or fluid outlet from reaching other parts of the microfluidic flow cell or from flowing off the flow cell.

### CROSS-REFERENCE TO RELATED APPLICATION(S)

This Application is a Section 371 National Stage Application of International Application No, PCT/EP2023/064515, filed May 13, 2023 and published as WO 2023/232849 A1 on Dec. 7, 2023, in English.

### BACKGROUND

The invention relates to a microfluidic flow cell intended for imaging a fluid, comprising a body which houses at least one fluid channel extending between a fluid inlet and a fluid outlet, wherein the at least one fluid channel comprises a channel part which is located at an imaging region intended for imaging said fluid present in the channel part of the fluid channel.

Within the context of the present invention, a fluid also encompasses a fluid in which components other than the fluid itself are present (for example (bio)molecules such as, for example, polypeptides or DNA or RNA molecules, biological samples, or biological tissue such as, for example, cells).

### SUMMARY

A microfluidic flow cell is characterized in that on the body at least one fluid barrier is provided intended for preventing fluid spilled, for example accidentally spilled, from, or in the vicinity of, any of the fluid inlet or fluid outlet from reaching other parts of the microfluidic flow cell or from flowing off the flow cell.

For example, at the imaging region an immersion oil film may be present on one surface of the body (for example at the side of a condenser) for improving the imaging quality. A fluid supplied to the fluid channel at the fluid inlet or discharged therefrom at the fluid outlet) may be water-based and, if such a water-based would come into contact and mix with the oil film, the imaging quality could be compromised by it (for example by the formation of water bubbles in the oil). The fluid barrier may prevent such an undesired contact. As another example, such a fluid barrier also may prevent that a fluid is spilled onto a piezo electric stage which may be present beneath the microfluidic flow cell.

The fluid barrier may be realized at many different positions. In accordance with one embodiment the respective one(s) of the fluid inlet and fluid outlet is/are positioned in a region/regions which is/each are surrounded by such a fluid barrier. Basically, this means that a respective region is fluidically isolated from other regions of the flow cell and that any fluid spilled from a fluid inlet or fluid outlet remains in said region.

In an embodiment of the microfluidic flow cell which is provided with at least two fluid channels, it is conceivable that corresponding fluid inlets and/or corresponding fluid outlets of the at least two fluid channels are positioned in a single region, such that the corresponding fluid inlets or corresponding fluid outlets of the at least two fluid channels are surrounded by a same, single fluid barrier. However, as an alternative it also is possible that each fluid inlet or fluid outlet is surrounded by its own, dedicated fluid barrier, but such an embodiment may increase the constructional complexity of the design of the flow cell.

In an alternative embodiment of the microfluidic flow cell the fluid barrier surrounds the imaging region. Such an embodiment offers the advantage that a single fluid barrier may suffice, even when multiple fluid inlets and fluid outlets are provided at different locations (for example at opposite sides of respective fluid channels).

In addition to the possibility to choose different locations for the fluid barrier(s), there also are many possibilities for designing such a barrier. In a very basic, yet nevertheless very effective embodiment of the microfluidic flow cell, the fluid barrier may comprise an elevated rim projecting from a surface of the body. Basically, this means that both the respective region inside of the fluid barrier and a region outside of it are part of a same surface of the body (and thus are substantially located at a same level), wherein the elevated rim precludes any spilled fluid from flowing from one region (the region inside the fluid barrier) towards another region (the region outside the fluid barrier).

In an alternative embodiment of the microfluidic flow cell, the region is defined by a depressed region of the surface of the body, of which an outer boundary defines the fluid barrier. In this context, the outer boundary generally is defined by the transition between the depressed region and the surrounding original surface of the body, which transition may comprise a surrounding wall part extending at an angle (for example a right angle) relative to the surface of the body. In this embodiment, the level of the region inside the fluid barrier is lower than the level of the region outside the fluid barrier.

In yet another embodiment the fluid barrier may comprises a hydrophobic surface portion, such as a hydrophobic strip, of the body. Such a hydrophobic surface portion may extend at the same level as the region inside the fluid barrier (although its level also may be raised or lowered to some extent). Such a hydrophobic surface portion may define an effective fluid barrier, especially in cases where the fluid supplied to or discharged from a fluid channel is water-based.

In one embodiment of the microfluidic flow cell, the body defines a body user access side, wherein for at least one fluid channel at least one, and preferably both, of its fluid inlet and fluid outlet is/are offset in a direction towards the body user access side of the body relative to at least said part of the fluid channel located at the imaging region. As a result, the respective fluid inlet and/or fluid outlet is readily accessible (for example for pipetting purposes) despite the provision of devices (such as external imaging means like condenser and objective) at the imaging region.

Further it is conceivable that the body is provided with reference marks intended for alignment purposes of the micro-fluidic flow cell relative to external imaging means intended for imaging the fluid. This allows for an automated optimal positioning of the flow cell. These reference marks may be such that they can be imaged using the same imaging modality that is used for imaging the fluid (e.g. a fluorescence imaging modality or a bright field imaging modality).

When, in accordance with yet another embodiment, the fluid inlet and fluid outlet are provided with Luer standard dimensions, the microfluidic flow cell can easily be connected to standardized external equipment. This effect can be further optimized when, in yet a further embodiment, the fluid inlet and fluid outlet are arranged for use as or with standard Luer lock connectors.

In an embodiment of the microfluidic flow cell the distance separating corresponding fluid inlets or corresponding fluid outlets is sufficient for allowing the provision of caps on the fluid inlets or fluid outlets, wherein said caps may have a venting or sealing (e.g. non-venting) capability.

In one embodiment of the microfluidic flow cell at least one additional channel is provided intended for housing a solution comprising microbeads, wherein the at least one fluid channel and the at least one additional channel are connected by a connection channel intended for moving microbeads from the at least one additional channel towards the at least one fluid channel using optical tweezers.

When such a microfluidic flow cell is intended for use with microbeads having a diameter ranging from 500 nm to 10 μm, the connection channel may have a width in a range from 0.05 to 1 mm, preferably a range from 0.1 to 0.6 mm and more preferably a range from 0.2 to 0.5 mm.

In an embodiment the microfluidic flow cell has a connection channel that has a length ranging preferably from 0.5 to 2.5 mm, more preferably has a length of 1 mm, and wherein the connection channel may taper over at least part of its length.

In yet another embodiment the at least one fluid channel is positioned between a flow cell body lower wall and a flow cell body upper wall, wherein at the imaging region the total height as defined by the sum of the thickness of the flow cell body lower wall, internal height of the fluid channel and thickness of the flow cell body upper wall is at most 1300 μm, and wherein the thickness of the flow cell body lower wall ranges from 100 to 250 μm, for example from 150 to 250 μm, and the internal height of the fluid channel ranges from 50 to 500 μm. Such parameters contribute to a good imaging quality in the imaging region (especially with a condenser of the imaging means positioned above the flow cell and an objective positioned below the flow cell). This is especially important when optical tweezers are used in combination with high numerical aperture oil immersion condensers (e.g. using an aplanatic oil immersion condenser with a numerical aperture of 1.4). Since such condensers typically have a short working distance and need to be focused in the same plane as the focus of the optical trap, the distance between the top surface and the channel where the trapping is performed cannot be too large.

In an embodiment the flow cell body lower wall is made of a plastic material or glass, while the flow cell body upper wall is made of a plastic material.

In a specific embodiment the thickness of the flow cell body lower wall is about (substantially) 175 μm, and the internal height of the fluid channel is about (substantially) 400 μm. In another specific embodiment the thickness of the flow cell body lower wall is about (substantially) 175 μm, and the internal height of the fluid channel is in a range from 200 μm to 400 pin, and preferably is 200 μm. Such a thickness and internal height can ensure high quality imaging and trapping since optical aberrations can be minimized.

### BRIEF DESCRIPTION OF THE DRAWINGS

Hereinafter aspects of the invention will be elucidated while referring to the drawings, in which:

FIG. 1 is a perspective view of an embodiment of a microfluidic flow cell;

FIG. 2 is a top plan view;

FIG. 3 is a frontal view:

FIG. 4 is a cross-sectional view according to IV-IV in FIG. 2;

FIG. 5 is a cross-sectional view according to V-V in FIG. 3;

FIG. 6 is a top plan view of another embodiment of a microfluidic flow cell, and

FIG. 7 is a perspective view of said other embodiment.

### DETAILED DESCRIPTION OF THE ILLUSTRATIVE EMBODIMENTS

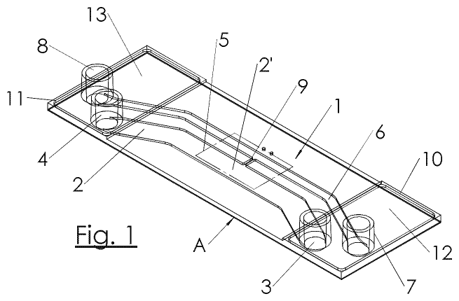

Referring to the FIGS. 1-3, an embodiment of a microfluidic flow cell is illustrated. The flow cell is intended for imaging a fluid (or more particularly biological samples or tissue present in the fluid). The flow cell comprises a body 1 which houses a fluid channel 2 for the fluid to be imaged extending between a fluid inlet 3 and a fluid outlet 4. It is noted that the illustrated positions of the fluid inlet 3 and fluid outlet 4 may be swapped.

The fluid channel 2 comprises a channel part 2′ which is located at an imaging region 5 (indicated schematically by a dotted square) intended for imaging said fluid present in the channel part of the fluid channel. In other non-illustrated embodiments, there may be multiple fluid channels.

In the illustrated embodiment the flow cell further comprises an additional channel 6 with fluid inlet 7 and fluid outlet 8 (the positions of which may be swapped as well). This additional channel is intended for housing a solution comprising microbeads. The fluid channel 2 and the additional channel 6 are connected by a connection channel 9 intended for moving the microbeads from the additional channel towards the fluid channel (for example by means of optical tweezers not illustrated). The provision of such an additional channel may improve the functionality of the flow cell (e.g. in improving the manipulation capabilities and use of said microbeads).

In an embodiment of the microfluidic flow cell intended for use with microbeads having a diameter ranging from 500 nm to 10 μm, the connection channel may have a width in a range from 0.05 to 1 mm, preferably in a range from 0.1 to 0.6 mm and more preferably in a range from 0.2 to 0.5 mm, wherein the connection channel may have a length ranging preferably from 0.5 to 2.5 mm, more preferably has a length of 1 mm. The connection channel may taper over at least part of its length (in a direction from the additional channel towards the fluid channel), e.g., see FIGS. 6 and 7.

On the body 1 two fluid barriers 10 and 11 are provided intended for preventing fluid accidentally spilled from any of the fluid inlets 3,7 or fluid outlets 4,8 from reaching other parts of the microfluidic flow cell, such as for example the imaging region 5.

In the illustrated embodiment the respective ones of the fluid inlets 3,7 and fluid outlets 4,8 are positioned in regions 12 and 13, respectively, which are surrounded by the respective fluid barriers 10 and 11. Thus, in this embodiment corresponding fluid inlets 3,7 and corresponding fluid outlets 4,8 of the fluid channel 2 and additional channel 6 are positioned in the same region (12 and 13, respectively) and are surrounded by a same, single fluid barrier 10 and 11, respectively.

In particular referring to FIG. 4, one can see that the fluid barrier 10 comprises an elevated rim projecting from a surface of the body 1. In the illustrated embodiment that applies too for the fluid barrier 11.

In an alternative embodiment (not illustrated) a fluid barrier could be provided (as an alternative or in addition) which surrounds the imaging region 5 of the body 1.

In yet another embodiment (not illustrated) the region or regions (for example regions 12 and 13) may be defined by a depressed region of the surface of the body 1, of which an outer boundary defines the fluid barrier.

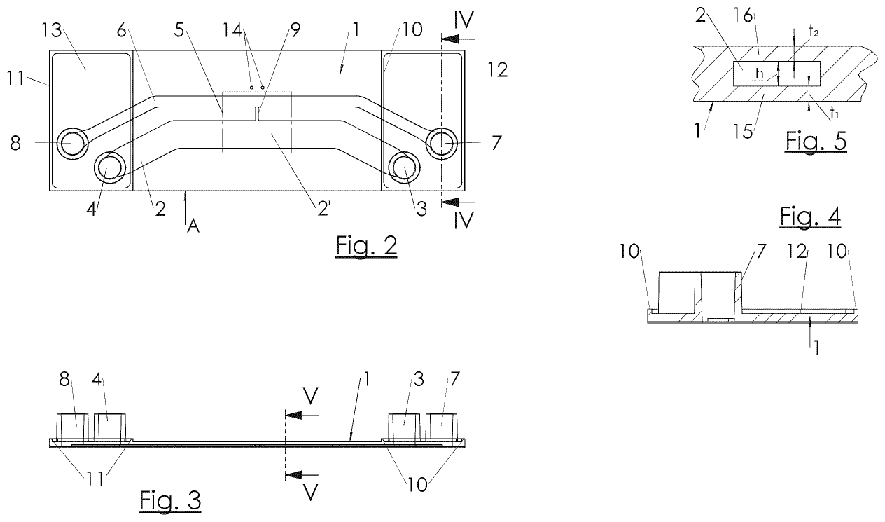

The body 1 of the flow cell defines a body user access side (indicated by arrow A in FIGS. 1 and 2), and the fluid inlets 3,4 and fluid outlets 7,8 are offset in a direction towards the body user access side A of the body relative to at least said part 2′ of the fluid channel 2 (and a corresponding part of the additional channel 6) located at the imaging region 5.

For example referring to FIG. 2, the body 1 is provided with reference marks 14 (such as dots) intended for alignment purposes of the microfluidic flow cell with respect to external imaging means intended for imaging the fluid.

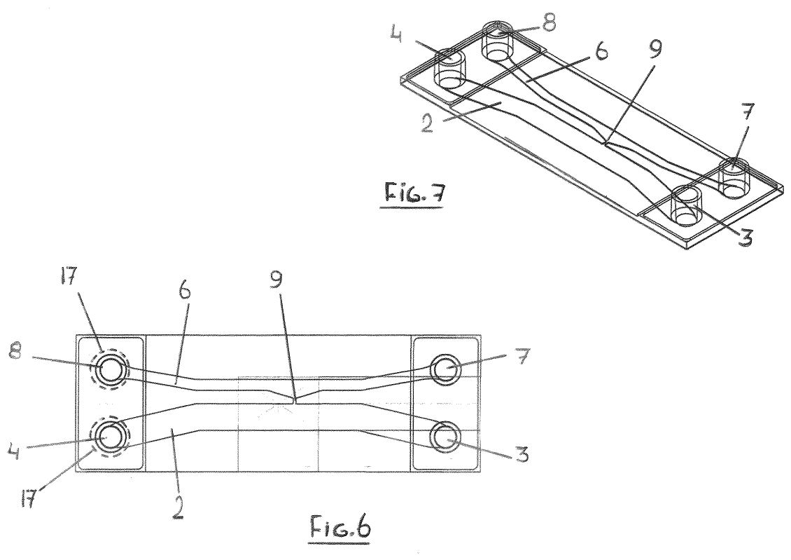

Referring to FIG. 5, the fluid channel 2 is positioned between a flow cell body lower wall (or bottom cover) 15 (which preferably is made of plastic material or of glass) and a flow cell body upper wall (or top cover) 16 (which preferably is made of plastic material). Preferably, at the imaging region 5 the total height as defined by the sum of the thickness t₁ of the flow cell body lower wall 15, internal height h of the fluid channel 2 and thickness t₂ of the flow cell body upper wall 16 is at most 1300 μm, wherein the thickness t₁ of the flow cell body lower wall 15 ranges from 150 to 250 μm and the internal height h of the fluid channel 2 ranges from 50 to 500 μm. In a preferred embodiment the thickness t₁ of the flow cell body lower wall 15 is about 175 μm and the internal height h of the fluid channel 2 is in a range from 200 μm to 400 μm, and preferably is 200 μm.

Finally referring to FIGS. 6 and 7, an embodiment is illustrated wherein the distance separating corresponding fluid inlets 3 and 7 (or corresponding fluid outlets 4 and 8) is sufficient for allowing the provision of caps (indicated schematically by broken lines 17 in FIG. 6 only) on the fluid inlets (or outlets, not shown). Such caps 17 may have a venting capability or may completely seal the inlets (outlets).

The invention is not limited to the embodiments described which may be varied widely within the scope of the invention as defined by the appending claims.

1. A microfluidic flow cell intended for imaging a fluid, comprising a body which houses at least one fluid channel extending between a fluid inlet and a fluid outlet, wherein the at least one fluid channel comprises a channel part which is located at an imaging region configured to image said fluid present in the channel part of the fluid channel, wherein on the body at least one fluid barrier is configured to prevent fluid spilled from reaching other parts of the microfluidic flow cell or from flowing off the flow cell.

2. The microfluidic flow cell according to claim 1, wherein the respective one(s) of the fluid inlet and fluid outlet is/are positioned in a region/regions which is/each are surrounded by a fluid barrier.

3. The microfluidic flow cell according to claim 2, and provided with at least two fluid channels, wherein corresponding fluid inlets and/or corresponding fluid outlets of the at least two fluid channels are positioned in a single region, such that the corresponding fluid inlets or corresponding fluid outlets of the at least two fluid channels are surrounded by a same, single fluid barrier.

4. The microfluidic flow cell according to claim 1, wherein the fluid barrier surrounds the imaging region.

5. The microfluidic flow cell according to claim 1, wherein the fluid barrier comprises an elevated rim projecting from a surface of the body.

6. The microfluidic flow cell according to claim 1, wherein the region is defined by a depressed region of a surface of the body, of which an outer boundary defines the fluid barrier.

7. The microfluidic flow cell according to claim 1, wherein the fluid barrier comprises a hydrophobic surface portion of the body.

8. The microfluidic flow cell according to claim 1, wherein the body defines a body user access side, and wherein for at least one fluid channel at least one of its fluid inlet and fluid outlet is/are offset in a direction towards the body user access side of the body relative to at least said channel part of the fluid channel located at the imaging region.

9. The microfluidic flow cell according to claim 1, wherein the body is provided with reference marks configured for alignment purposes of the microfluidic flow cell with respect to external imaging means intended for imaging the fluid.

10. The microfluidic flow cell according to claim 1, wherein the fluid inlet and fluid outlet are provided with Luer standard dimensions.

11. The microfluidic flow cell according to claim 1, wherein the fluid inlet and fluid outlet are arranged for use as or with standard Luer lock connectors.

12. The microfluidic flow cell according to claim 1, wherein at least one additional channel is configured to house a solution comprising microbeads and wherein the at least one fluid channel and the at least one additional channel are connected by a connection channel configured to move microbeads from the at least one additional channel towards the at least one fluid channel using optical tweezers.

13. The microfluidic flow cell according to claim 12, wherein the microfluidic flow cell is configured for use with microbeads having a diameter ranging from 500 nm to 10 pmm, and wherein the connection channel has a width in a range from to 0.05 to 1 mm.

14. The microfluidic flow cell according to claim 1, wherein the at least one fluid channel is positioned between a flow cell body lower wall and a flow cell body upper wall, wherein at the imaging region a total height as defined by a sum of a thickness of the flow cell body lower wall, internal height of the fluid channel and thickness of the flow cell body upper wall is at most 1300 pm, and wherein a thickness of the flow cell body lower wall ranges from 150 to 250 pm and an internal height of the fluid channel ranges from 50 to 500 pm.

15. The microfluidic flow cell according to claim 14, wherein the thickness of the flow cell body lower wall is about 175 pm, and the internal height of the fluid channel is in a range from 200 pm to 400 pm.

16. The microfluidic flow cell according to claim 14, wherein the flow cell body upper wall is made of plastic material and wherein the flow cell body lower wall is made of plastic material or of glass.

17. The microfluidic flow cell according to claim 1 and provided with multiple fluid channels, wherein at least some of the multiple fluid channels have different internal heights.

18. The microfluidic flow cell according to claim 3, wherein a distance separating corresponding fluid inlets or corresponding fluid outlets is sufficient for allowing caps on the fluid inlets or fluid outlets, wherein said caps have a venting or sealing capability.

19. The microfluidic flow cell according to claim 7, wherein the hydrophobic surface portion is a hydrophobic strip.

20. The microfluidic flow cell according to claim 1, wherein the body defines a body user access side, and wherein for at least one fluid channel its fluid inlet and fluid outlet are offset in a direction towards the body user access side of the body relative to at least said channel part of the fluid channel located at the imaging region.
